(19) United States
(12) Patent Application Publication
(10) Pub. No.: US 2008/0157032 A1
(43) Pub. Date: Jul. 3, 2008

(54) METHOD FOR MANUFACTURING LIGHT-EMITTING MATERIAL

(75) Inventors: Junichiro SAKATA, Atsugi (JP); Yoshiaki YAMAMOTO, Atsugi (JP); Yayoi TOYOSUMI, Atsugi (JP)

Correspondence Address: FISH & RICHARDSON P.C., P.O. BOX 1022, MINNEAPOLIS, MN, 55440-1022, US

(73) Assignee: SEMICONDUCTOR ENERGY LABORATORY CO., LTD., Atsugi-shi (JP)

(21) Appl. No.: 11/873,041

(22) Filed: Oct. 16, 2007

(30) Foreign Application Priority Data
Oct. 17, 2006 (JP) 2006-283136

(51) Int. Cl. C09K 11/64

(52) U.S. Cl. 252/519.4

(57) ABSTRACT

There has been a problem in that kinds of conventional light-emitting materials are not sufficient; therefore, choices of materials and manufacturers of light emitting materials are limited, resulting in an expensive light-emitting device. The present invention provides a novel method for manufacturing a light-emitting material suitable for mass production that can be manufactured at a low cost, and a novel light-emitting material which can provide light emission with high intensity. A mixture in which CuAlS₂ is added in a small amount into ZnS as a base material is put in a reaction container. Then, the reaction container is hermetically sealed and the mixture is baked. Note that the reaction container is preferably hermetically sealed in a state where a reduced pressure is held in the reaction container. Further, in a light-emitting element using a light-emitting material obtained, electroluminescence with high luminance can be obtained.

### TECHNICAL FIELD

The present invention relates to a novel method for manufacturing a light-emitting material forming an electroluminescent element which can be formed as a thin film and provide sufficient luminance.

### BACKGROUND ART

In recent years, a light-emitting element that uses electroluminescence has attracted attention as a light source such as a point light source or a linear light source, or as a display device such as a television or a mobile information terminal. This light-emitting element includes a light-emitting material interposed between a pair of electrodes and can provide light emission from the light-emitting material by voltage application.

A light-emitting element that uses electroluminescence is classified by whether a light-emitting material is an organic compound or an inorganic compound. In general, the former is referred to as an organic EL element and the latter is referred to as an inorganic EL element.

An inorganic EL element is classified into a dispersion-type inorganic EL element and a thin-film-type inorganic EL element, depending on its element structure. The former and the latter are different in that the former has a light-emitting layer in which particles of a light-emitting material are dispersed in a binder, whereas the latter has a light-emitting layer formed of a thin film of a light-emitting material; however, the former and the latter share a common feature that they need electrons accelerated by a high electric field. Note that, as a mechanism of light emission that is obtained, there are donor-acceptor recombination-type light emission that utilizes a donor level and an acceptor level, and localized-type light emission that utilizes inner-shell electron transition of a metal ion. In general, it is often the case that a dispersion-type inorganic EL element exhibits donor-acceptor recombination-type light emission and a thin-film-type inorganic EL element exhibits localized-type light emission.

Non-patent document 1 (K. Tanaka et al., “Red Electroluminescence of Mn-doped CuAlS₂ Powder and Single Crystal”, Japanese Journal of Applied Physics, Vol. 37, 1998, pp. 3350-3356) discloses that red light emission can be obtained by using a phosphor powder in which Mn as a luminescence center material is added and mixed into CuAlS₂ as a base material.

### DISCLOSURE OF INVENTION

A method for manufacturing a phosphor powder in which Mn as a luminescence center material is added and mixed into CuAlS₂ as a base material has problems of difficulty in mass production of a phosphor with high purity, reduction in manufacturing yield and a high price of a phosphor because it is difficult to obtain and manufacture a highly pure material.

Further, conventionally, there has also been a problem in that kinds of light-emitting materials are not sufficient; therefore, choices of materials and manufacturers of light emitting materials are limited, resulting in an expensive light-emitting device.

The present invention provides a novel method for manufacturing a light-emitting material, which is suitable for mass production and can be manufactured at low cost, and a novel light-emitting material which can provide light emission with high intensity.

The inventors have discovered that when a mixture in which CuAlS₂ is added in a small amount into zinc sulfide (ZnS) as a base material is hermetically sealed in a reaction container and baked, at least one of the above-described problems can be solved. Note that in being hermetically sealed, the reaction container is preferably hermetically sealed in a state where a reduced pressure is held in the reaction container.

One aspect of the invention disclosed in this specification is a method for manufacturing a light-emitting material including the steps of preparing a mixture of ZnS and CuAlS₂, putting the mixture of ZnS and CuAlS₂ in a reaction container, hermetically sealing the reaction container in a state where a reduced pressure is held in the reaction container, and baking the mixture in the hermetically-sealed reaction container.

In addition, a method for manufacturing a powder of CuAlS₂ is also included in the scope of the present invention. Another aspect of the present invention disclosed in this specification is a method for manufacturing a light-emitting material including the steps of putting a mixture of a material including sulfur, a material including copper and a material including aluminum or a mixture of copper sulfide and aluminum sulfide in a first reaction container, hermetically sealing the first reaction container in a state where a reduced pressure is held in the first reaction container, baking the mixture in the hermetically-sealed first reaction container to obtain CuAlS₂, preparing a mixture of ZnS and CuAlS₂, putting the mixture of ZnS and CuAlS₂ in a second reaction container, hermetically sealing the second reaction container in a state where a reduced pressure is held in the second reaction container, and baking the mixture of ZnS and CuAlS₂ in the hermetically-sealed second reaction container.

ZnS is a relatively inexpensive material and suitable for a base material of a light-emitting material. Further, a powder of CuAlS₂ that is added into ZnS in a small amount can also be manufactured by using copper sulfide and aluminum sulfide at a low cost.

Non-Patent Document 1 discloses a phosphor powder where Mn as a luminescence center material is added and mixed into CuAlS₂ as a base material; however, the phosphor powder is greatly different from a light-emitting material that is disclosed in the present invention. In a light-emitting material in the present invention, CuAlS₂ is not a base material but an additive. That is, in the light-emitting material disclosed in the present invention, CuAlS₂ is mixed in a light-emitting material at least in such a proportion that CuAlS₂ does not serve as a base material. When CuAlS₂ is added into ZnS in the above manufacturing method so that a weight of CuAlS₂ is less than that of ZnS, an obtained light-emitting material exhibits electroluminescence. Preferably, when a weight of CuAlS₂ added into ZnS is set to be 0.01 wt % to 10 wt % with respect to ZnS to form a light-emitting material, high luminance is obtained in a dispersion-type light-emitting element using the light-emitting material obtained.

Further, electroluminescence can not be confirmed at all in a mixture obtained by mixing Al₂S₃ and a material in which Cu as a luminescence center material is added and mixed into ZnS as a base material (referred to as ZnS:Cu). Furthermore, the material (ZnS:Cu) is an expensive material. Accordingly, a manufacturing method of the present invention is useful.

The present invention can provide a novel method for manufacturing a light-emitting material which can be manufactured at a low cost. Also, the present invention can provide a novel light-emitting material which can provide light emission with high intensity.

### BRIEF DESCRIPTION OF DRAWINGS

FIG. 1 is a flow chart showing manufacturing steps of the present invention.

FIG. 2 shows a result of XRD of a material after baking in Embodiment 1.

FIG. 3 shows a spectrum of photoluminescence (PL) of a light-emitting material in Embodiment 1.

FIG. 4 shows the spectrum of photoluminescence (PL) of a light-emitting material in Comparative Example.

FIG. 5 is a graph showing a voltage-luminance characteristic of a light-emitting material in Embodiment 1.

FIG. 6 shows a spectrum of electroluminescence (EL) of a light-emitting material in Embodiment 1.

FIG. 7 shows a frequency-luminance characteristic of a dispersion-type light-emitting element in Embodiment 2 at an alternating voltage V₍ₒ₋ₚ₎ of 400 V.

FIG. 8 is a graph showing luminance relative to concentration of CuAlS₂.

### BEST MODE FOR CARRYING OUT THE INVENTION

An embodiment mode of the present invention will be described below.

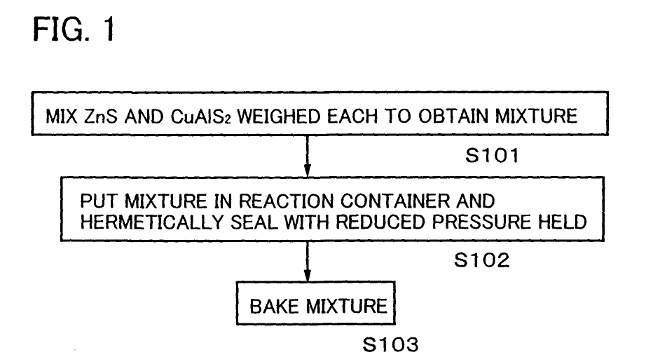

FIG. 1 is a flow chart illustrating how a light-emitting material is obtained from sulfide. In order to manufacture a desired light-emitting material, first of all, ZnS and CuAlS₂ each of which is weighed are mixed to obtain a mixture (S101).

Next, the mixture is sealed in a reaction container. Here, the reaction container is hermetically sealed in a state where a reduced pressure is held in a reaction container (S102). A known quartz tube is used as the reaction container.

Then, the mixture is baked at temperatures of 1000° C. or more (S103). The melting point of CuAlS₂ is 1302° C., and therefore it is preferably baked at temperatures of 1000° C. or more. Also, the mixture can be baked in a relatively short time, approximately for three hours.

In the mixture obtained in the above manner, electroluminescence (EL) can be observed and high light emission intensity can be obtained.

Also, a method for manufacturing CuAlS₂ is not particularly limited. CuAlS₂ may be formed using a material including sulfur, a material including copper, and a material including aluminum. Copper sulfide is a chemically stable material; therefore, copper sulfide is preferable as one of the materials for manufacturing CuAlS₂. Further, materials in a powder form are favorable for mixture; therefore, it is desirable to manufacture CuAlS₂ using copper sulfide and aluminum sulfide.

The present invention including the above-described structure will be explained in more detail in the embodiments shown below.

### EMBODIMENT 1

First, CuAlS₂ was manufactured. Copper sulfide (Cu₂S) and aluminum sulfide (Al₂S₃) which were weighed to be 2.5640 g and 2.4183 g respectively were put in a glass bottle and stirred by a stirrer for 30 minutes to be mixed. Next, the mixture was taken out from the glass bottle and put in a graphite crucible. And then, the graphite crucible was inserted into a quartz tube, and air in the quartz tube was exhausted so that a state under a reduced pressure of 1×10⁻³ Pa or less was obtained. Then, the quartz tube was sealed by welding using an oxyhydrogen burner and a sealed reduced-pressure quartz tube was manufactured.

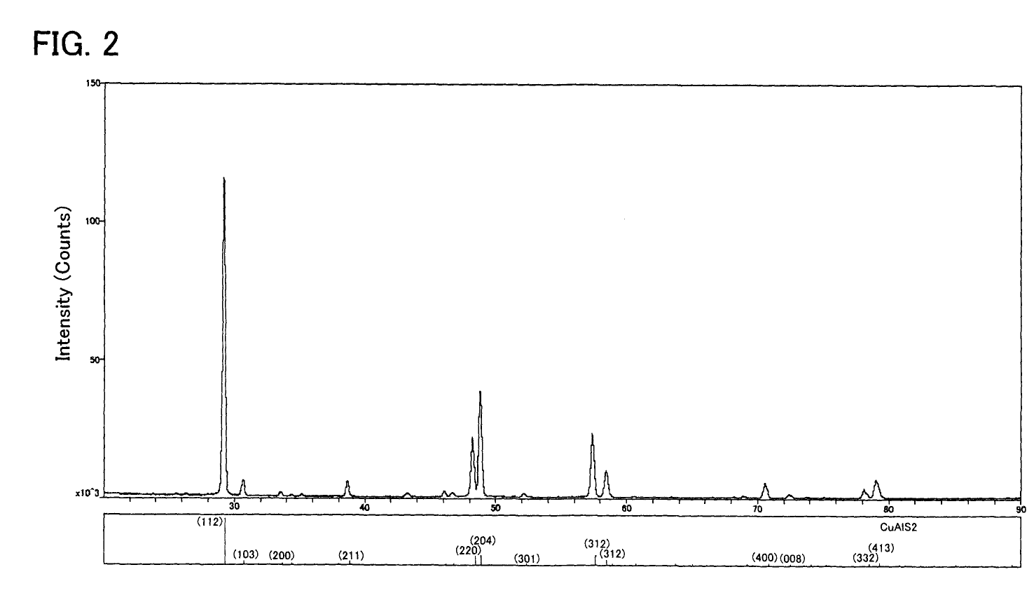

Then, the sealed reduced-pressure quartz tube was placed in a tubular furnace and the mixture was baked at a temperature of 1250° C. for 3.5 hours. The resulting material in the graphite crucible which was taken out after cooling was black in color. FIG. 2 shows a result of XRD of the material after baking. A peak position thereof coincided with that of CuAlS₂, and a lattice constant was a=0.53446 nm and c=1.04257 nm, and a crystal system was a tetragonal system, whereby it was confirmed that CuAlS₂ was made.

Then, a procedure for manufacturing a light-emitting material where ZnS is used as a base material and CuAlS₂ is contained in a small amount will be described below.

First, ZnS and CuAlS₂ manufactured by the above-described method were weighed to be 5 g and 0.0125 g respectively, and they were put in a glass bottle and stirred by a stirrer for 30 minutes to be mixed. Next, the mixture was taken out from the glass bottle and put in a graphite crucible. And then, the graphite crucible was inserted into a quartz tube, and air in the quartz tube was exhausted so that a state under a reduced pressure of 1×10⁻³ Pa or less was obtained. Then, the quartz tube was sealed by welding using an oxyhydrogen burner and a sealed reduced-pressure quartz tube was manufactured.

Next, the sealed reduced-pressure quartz tube was placed in a muffle furnace and the mixture was baked at a temperature of 1250° C. for 3 hours. The resulting material in the graphite crucible which was taken out after cooling was pale yellow in color. The material after baking was put in 1 N HCl, and they were stirred for an hour. The obtained solution was filtered, the residue was washed with pure water, the residue was put in an aqueous solution prepared to include 15 wt % H₂O₂, 6.75 wt % diethylene triamine pentaacetic acid (DTPA) and 4.2 wt % NaOH, and they were stirred for an hour. Then, the solution was filtered and the residue was washed with pure water.

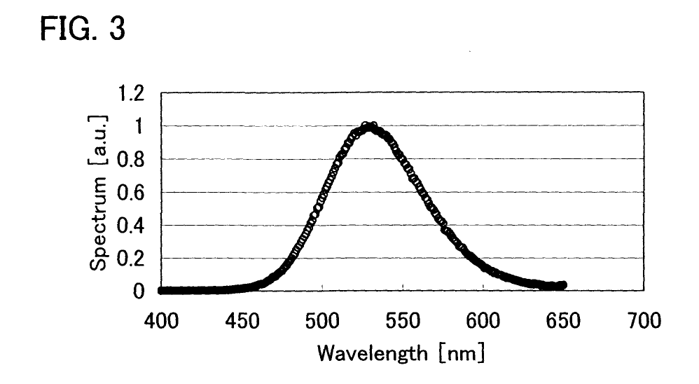

FIG. 3 shows photoluminescence (PL) of the material obtained. Green photoluminescence with a peak at a wavelength λ of 530 nm could be confirmed.

### Comparative Example

ZnS:Cu (manufactured by Osram Sylvania Inc.) and Al₂S₃ were weighed to be 5 g and 0.0193 g respectively and they were put in a glass bottle and stirred by a stirrer for 30 minutes to be mixed. Next, the mixture was taken out from the glass bottle and put in a graphite crucible. And then, the graphite crucible was inserted into a quartz tube, and air in the quartz tube was exhausted so that a state under a reduced pressure of 1×10⁻³ Pa or less was obtained. Then, the quartz tube was sealed by welding using an oxyhydrogen burner and a sealed reduced-pressure quartz tube was manufactured.

Next, the sealed reduced-pressure quartz tube was placed in a muffle furnace and the mixture was baked at a temperature of 1250° C. for 3.5 hours. The resulting material which was taken out from the graphite crucible after cooling was pale yellow in color. The material after baking was put in 1 N HCl, and they were stirred for an hour. The obtained solution was filtered and the residue was washed with pure water. Further, the residue was put in an aqueous solution prepared to include 15 wt % H₂O₂, 6.75 wt % diethylene triamine pentaacetic acid (DTPA) and 4.2 wt % NaOH, and they were stirred for an hour. Then, the solution was filtered and the residue was washed with pure water.

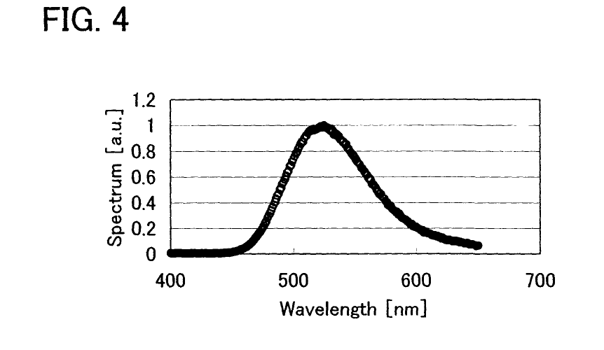

FIG. 4 shows photoluminescence (PL) of a light-emitting material obtained in the comparative example. Green photoluminescence with a peak at a wavelength λ of 525 nm could be confirmed.

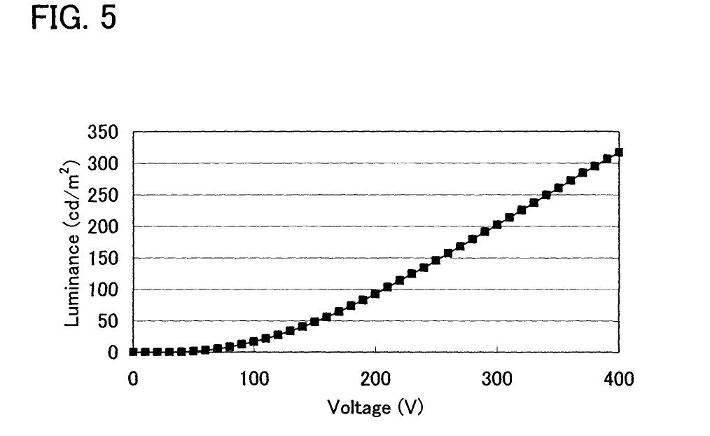

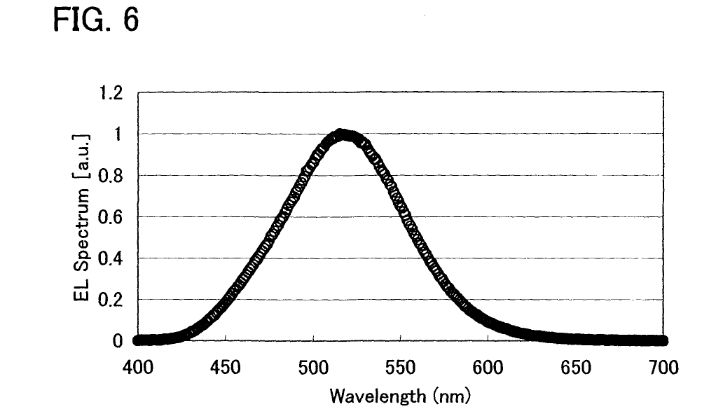

A dispersion-type light-emitting element was manufactured using the light-emitting material manufactured in this embodiment and another dispersion-type light-emitting element was manufactured using the light-emitting material manufactured in the comparative example. Then light emission of both of the elements was measured at an alternating voltage Vₒ₋ₚ of 400 V and a frequency f of 50 kHz. As a result thereof, electroluminescence (EL) could be confirmed only in the element using the light-emitting material of Embodiment 1. That is, in the light-emitting material manufactured in the comparative example, photoluminescence could be confirmed; however, electroluminescence could not be confirmed. FIG. 5 shows a voltage-luminance characteristic of the light-emitting material in this embodiment. FIG. 6 shows a spectrum of EL of the light-emitting material in this embodiment (measurement frequency: f=1 [kHz]). Green electroluminescence with the maximum luminance of 2000 cd/m² could be obtained.

Light-emitting efficiency of a donor-acceptor type phosphor is significantly affected by a transition probability. The transition probability W is represented by Formula 1.

$$W = {W}_{0} exp ( - \frac{2 r}{{r}_{B}} ) \qquad [ Formula 1 ]$$

W₀: constant, r_{B}: Bohr radius, r: donor-acceptor distance

It is found from Formula 1 that the smaller a donor-acceptor distance is, the larger the transition probability is and the higher the light-emitting efficiency is. That is, the inventors consider that a donor-acceptor distance of a phosphor of the present invention can be made small by manufacturing in advance a compound containing elements serving as a donor and an acceptor before mixing with ZnS, and as a result, a phosphor with high light-emitting efficiency can be manufactured.

This embodiment can be freely combined with the embodiment mode.

### EMBODIMENT 2

First, ZnS and CuAlS₂ manufactured in Embodiment 1 were weighed to be 5 g and 0.005 g respectively, and they were put in a glass bottle and stirred by a stirrer for 30 minutes to be mixed. Next, the mixture was taken out from the glass bottle and put in a graphite crucible. And then, the graphite crucible was inserted into a quartz tube, and air in the quartz tube was exhausted so that a state under a reduced pressure of 1×10⁻³ Pa or less was obtained. Then, the quartz tube was sealed by welding using an oxyhydrogen burner and a sealed reduced-pressure quartz tube was manufactured.

Next, the sealed reduced-pressure quartz tube was placed in a tubular furnace and the mixture was baked at a temperature of 1250° C. for 3 hours. The resulting material in the graphite crucible which was taken out after cooling was grayish white in color. The material after baking was put in a 10% acetic acid, and they were stirred for an hour. The obtained solution was filtered and the residue was washed with pure water. Further, the residue was put in an aqueous solution prepared to include 15 wt % H₂O₂, 6.75 wt % diethylene triamine pentaacetic acid (DTPA) and 4.2 wt % NaOH, and they were stirred for an hour. Then, the solution was filtered and the residue was washed with pure water.

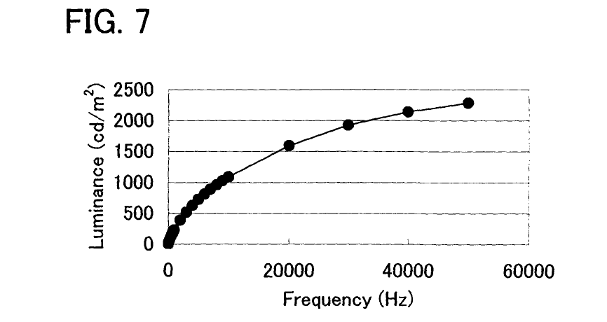

A dispersion-type light-emitting element was manufactured using the light-emitting material manufactured in this embodiment and another dispersion-type light-emitting element was manufactured using the light-emitting material manufactured in the comparative example. FIG. 7 shows a frequency-luminance characteristic at an alternating voltage Vₒ₋ₚ of 400 V. The higher a frequency is, the higher a luminance is, and electroluminescence with the maximum luminance of 2300 cd/m² could be obtained at a frequency f of 50 kHz.

This embodiment can be freely combined with any one of the embodiment mode and Embodiment 1.

### EMBODIMENT 3

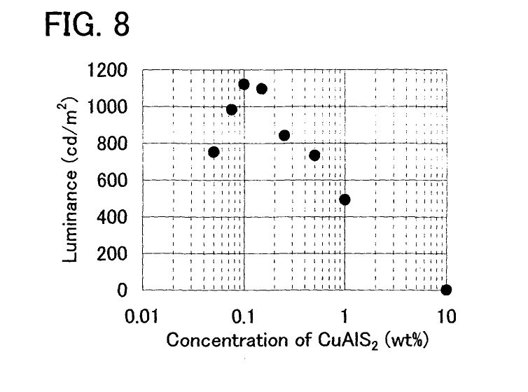

Concentrations of CuAlS₂ to be mixed with ZnS were made different, baking was performed in the same manner as that of Embodiment 1, and light-emitting materials with different concentrations of CuAlS₂ were manufactured. Note that washing of the light-emitting materials was not performed. Dispersion-type light-emitting elements were manufactured using the obtained light-emitting materials, and luminances were measured at an alternating voltage Vₒ₋ₚ 400 (V) and at a frequency f of 50 kHz. FIG. 8 is a graph which shows luminance relative to concentration of CuAlS₂. When the concentration of CuAlS₂ is 10 wt % or less, light emission can be obtained. When the concentration of CuAlS₂ is 0.1 wt %, a luminance of 1121 cd/m² can be obtained. Note that luminance tends to decrease when the concentration of CuAlS₂ is 0.1 wt % or less.

This embodiment can be freely combined with any one of the embodiment mode and Embodiment 1.

### INDUSTRIAL APPLICABILITY

The present invention can provide a novel method for manufacturing a light-emitting material suitable for mass production. A mixture in which CuAlS₂ is added in a small amount into ZnS as a base material has an advantage that the mixture can be obtained by baking in a relatively short time.

The present application is based on Japanese Patent Application serial No. 2006-283136 filed on Oct. 17, 2006 in Japan Patent Office, the entire contents of which are hereby incorporated by reference.

1. A method for manufacturing a light-emitting material, comprising the steps of:
preparing a mixture of zinc sulfide and CuAlS₂;
putting the mixture of zinc sulfide and CuAlS₂ in a reaction container;
hermetically sealing the reaction container in a state where a reduced pressure is held in the reaction container; and
baking the mixture in the hermetically-sealed reaction container.

2. The method for manufacturing a light-emitting material according to claim 1, wherein a weight of CuAlS₂ in the mixture of zinc sulfide and CuAlS₂ is less than a weight of zinc sulfide.

3. The method for manufacturing a light-emitting material according to claim 1, wherein a weight of CuAlS₂ in the mixture of zinc sulfide and CuAlS₂ is 0.01 wt % to 10 wt % with respect to a weight of zinc sulfide.

4. The method for manufacturing a light-emitting material according to claim 1, wherein the reduced pressure is 1×10⁻³ Pa or less.

5. A method for manufacturing a light-emitting material, comprising the steps of:
putting a mixture of a material including sulfur, a material including copper and a material including aluminum in a first reaction container;
hermetically sealing the first reaction container in a state where a reduced pressure is held in the first reaction container;
baking the mixture of the material including sulfur, the material including copper and the material including aluminum in the hermetically-sealed first reaction container to obtain CuAlS₂;
preparing a mixture of zinc sulfide and CuAlS₂;
putting the mixture of zinc sulfide and CuAlS₂ in a second reaction container;
hermetically sealing the second reaction container in a state where a reduced pressure is held in the second reaction container; and
baking the mixture of zinc sulfide and CuAlS₂ in the hermetically-sealed second reaction container.

6. The method for manufacturing a light-emitting material according to claim 5, wherein a weight of CuAlS₂ in the mixture of zinc sulfide and CuAlS₂ is less than a weight of zinc sulfide.

7. The method for manufacturing a light-emitting material according to claim 5, wherein a weight of CuAlS₂ in the mixture of zinc sulfide and CuAlS₂ is 0.01 wt % to 10 wt % with respect to a weight of zinc sulfide.

8. The method for manufacturing a light-emitting material according to claim 5, wherein the reduced pressure is 1×10⁻³ Pa or less.

9. A method for manufacturing a light-emitting material, comprising the steps of:
putting a mixture of copper sulfide and aluminum sulfide in a first reaction container;
hermetically sealing the first reaction container in a state where a reduced pressure is held in the first reaction container;
baking the mixture of copper sulfide and aluminum sulfide in the hermetically-sealed first reaction container to obtain CuAlS₂;
preparing a mixture of zinc sulfide and CuAlS₂;
putting the mixture of zinc sulfide and CuAlS₂ in a second reaction container;
hermetically sealing the second reaction container in a state where a reduced pressure is held in the second reaction container; and
baking the mixture of zinc sulfide and CuAlS₂ in the hermetically-sealed second reaction container.

10. The method for manufacturing a light-emitting material according to claim 9, wherein a weight of CuAlS₂ in the mixture of zinc sulfide and CuAlS₂ is less than a weight of zinc sulfide.

11. The method for manufacturing a light-emitting material according to claim 9, wherein a weight of CuAlS₂ in the mixture of zinc sulfide and CuAlS₂ is 0.01 wt % to 10 wt % with respect to a weight of zinc sulfide.

12. The method for manufacturing a light-emitting material according to claim 9, wherein the reduced pressure is 1×10⁻³ Pa or less.
